(19) United States
(12) Patent Application Publication
(10) Pub. No.: US 2007/0004458 A1
(43) Pub. Date: Jan. 4, 2007

(54) Method of designing a micro-bts

(76) Inventor: Chang Yoon Jung, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/560,149

(22) PCT Filed: Jul. 23, 2004
(86) PCT No.: PCT/KR04/01857

§ 371 Date: Jun. 15, 2006

(30) Foreign Application Priority Data
Jul. 24, 2003 (KR) 10-2003-0051160

(51) Int. Cl. H04B 1/38

(52) U.S. Cl. 455/561; 455/335

(57) ABSTRACT

The present invention relates to a method of designing a micro-Base Transceiver System (BTS) of a CDMA system. In a conventional micro-BTS, one Intermediate Frequency (IF) board has only one sector or Frequency Assignment (FA) therein, and a digital combiner and a switching logic are comprised in individual channel cards and IF boards. Thus, the FA to an IF board cannot avoid being fixed. However, according to the present invention, a digital combiner and a switching logic are transplanted in a main board of a micro-BTS, which operates as a backplane. By using this construction, the present invention can achieve a more efficient interface between a channel card and an IF board, and further increase the flexibility in establishing FAs.

### TECHNICAL FIELD

The present invention generally relates to a method of designing a structure for frequency assignment (FA) and sector pooling in a micro-base station transceiver subsystem (micro-BTS) so as to better efficiently establish a path for the interface between a channel card and an intermediate frequency (IF) board in the micro-BTS of a CDMA system. More particularly, the present invention relates to a method of designing a structure for FA and sector pooling to achieve more efficient interface by transplanting a digital combiner and a switching logic to a main board from individual channel cards and IF boards in the BTS.

### Background Art

In the conventional BTS, individual I/Q data transmitted from the CSM5000s of a channel card through a forward path are generally distributed to individual sectors according to the pattern on a backplane and inputted into individual IF boards. The inputted I/Q serial data are converted into parallel data and combined to individual FAs. Further, the combined data are inputted into a digital signal processor (DSP) for the process of individual FAs and then transmitted to an RF back after being converted into analog signals by a Digital to Analog (D/A) converter. In this case, each of the IF boards is commonly fixed to be dedicated to one sector.

Thus, with the conventional structure, sector pooling between the boards cannot be achieved to thereby deprive the functional capabilities of the fixed IF boards.

### Disclosure of Invention

Technical Problem

It is, therefore, the object of the present invention to address and resolve the above disadvantage associated with the conventional structure.

The object of the present invention is to transplant a digital combiner and a switching logic to a main board, which also functions as a backplane, from individual channel cards and IF boards in the BTS. By transplanting the digital combiner to the main board, better flexible path establishment and more efficient interface between the channel cards and the IF boards can be formed. This results in improved FA and sector pooling in the micro-BTS.

Technical Solution

In order to achieve the above objects, the present invention provides a method of designing a micro-BTS of a CDMA system. It includes at least one channel card, at least one intermediate frequency IF board, a BTS control board, a digital combiner in a forward path of the BTS, a switching logic in a reverse path of the BTS, and a main board. The method comprises the step of embedding the digital combiner and the switching logic in the main board, wherein said main board acts as a backplane.

According to a preferred embodiment of the present invention, the BTS control board and the backplane are also embedded in the main board. The digital combiner is embedded between the at least one channel card and the at least one IF board of the main board.

According to another preferred embodiment of the present invention, I/Q data inputted from the forward path are combined to transmit serial data to individual channels of the at least one IF board. Further, the data inputted from the at least one IF board are transmitted via the switching logic in the reverse path.

Advantageous Effects

According to the features of the present invention, better flexible path establishment and more efficient interface between the channel cards and the IF boards can be enabled by transplanting the digital combiner and the switching logic to the main board, which functions as a backplane, from the individual channel cards and the IF boards in the BTS.

Further, different from the conventional BTS where an IF board is fixed to be dedicated to only one sector or one FA, the BTS designed in accordance with the present invention can increase the flexibility in establishing the path to the FA or sector by transplanting the combiner to the main board.

Additionally, since the combiner and the switching logic are embedded in the main board, the present invention can save costs for the combiners and the switching logics that have been embedded in individual channel cards and IF boards.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 illustrates an overview of a structure for FA and sector pooling according to the present invention.

FIG. 2 illustrates a schematic diagram of the data flow from the channel card to the IF board according to the present invention.

FIG. 3 illustrates a schematic diagram of the data flow from the IF board to the channel card according to the present invention.

### BEST MODE FOR CARRYING OUT THE INVENTION

Hereinafter, preferred embodiments according to the present invention will be described and illustrated with reference to the accompanying drawings.

First, according to the present invention, the digital combiner, which has been embedded in each of the IF boards, is embedded between the channel card and the IF board. Further, the BTS control processor assembly (BCPA), which has been controlling the BTS, is configured to control the digital combiner and the reverse path switching logic in the main board.

The overview of the system according to the present invention is described by the following.

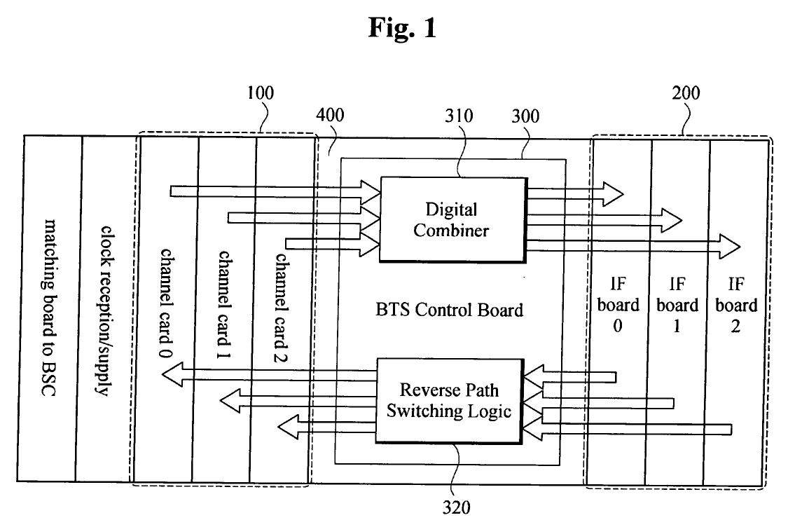

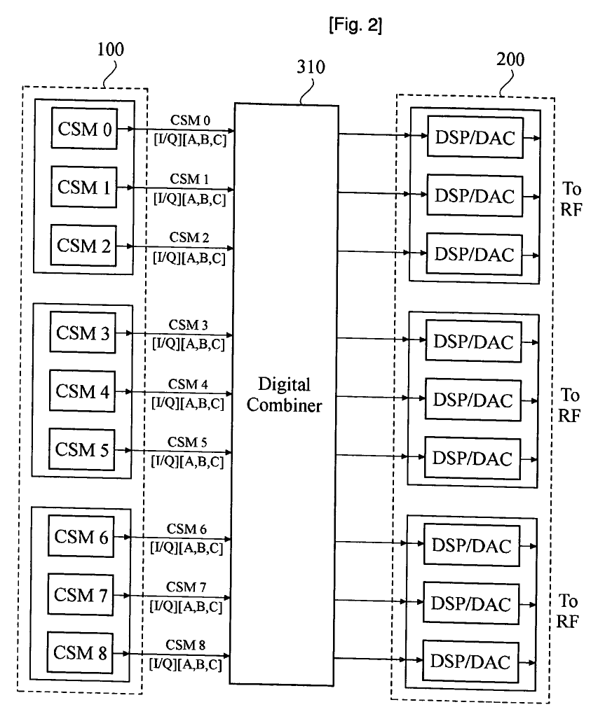

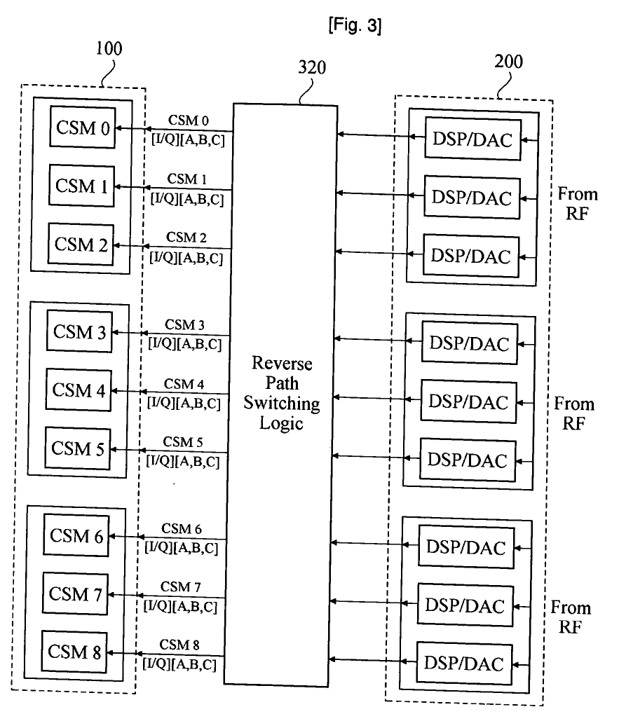

FIG. 1 illustrates an overview of a structure for FA and sector pooling according to the present invention. FIG. 2 illustrates a schematic diagram of the data flow from the channel card to the IF board according to the present invention. FIG. 3 illustrates a schematic diagram of the data flow from the IF board to the channel card according to the present invention.

Channel card 100, IF board 200, digital combiner 310, reverse path switching logic 320, BTS control board 300, and main board 400 are shown in the drawings. Other boards (e.g., a matching board to the BTS, a dock reception/supply board, a channel card, and a IF board), which are not referenced with numerals, are configured as conventional boards. The backplane, BTS control board 300, digital combiner 310, and reverse path switching logic 320 are incorporated in the main board.

With reference to FIG. 2, the data flow from the channel card to the IF board is described by the following. Assuming that 3 channel cards consisting of 3 CSM5000s are used in the forward path and 3 sectors per CSM5000 are used, 54 I/Q data inputs are directed to the digital combiner. Then, the digital combiner combines the data inputs as desired to transmit the serial data to each channels of the DSPs of IF board 200. Thus, the structure for FA and sector pooling is dependent on how the programmable logic device (PLD) is configured in the digital combiner.

With reference to FIG. 3, the data flow from the IF board to the channel card is described by the following. As shown therein, the structure can also be desirably configured through embedding the reverse path switching logic 320 in the main board 400.

### INDUSTRIAL APPLICABILITY

Assuming that 3 FAs, 3 sectors and diversity are provided, then the total of 18 data inputs are needed. This also means that 6 output pins per CSM5000 are needed, which requires the total of 54 output pins. Therefore, with the present invention, a micro-BTS of 3 FAs, 3 sectors and channel 288 can be achieved. More FAs and sectors can be provided according to the performance of the PLD and the main board.

Additional modifications and improvements of the present invention for FA and sector pooling in the micro-BTS may also be apparent to those of ordinary skill in the art. Thus, the particular descriptions herein is intended to represent only certain embodiments of the present invention, and is not intended to serve as limitations of an alternative BTS structure within the scope of the invention.

1. A method of designing a micro-Base Transceiver Subsystem (BTS) of a CDMA system, including at least one channel card, at least one intermediate frequency (IF) board, a BTS control board, a digital combiner in a forward path of the BTS, a switching logic in a reverse path of the BTS, and a main board, said method comprising the step of embedding the digital combiner and the switching logic in the main board, wherein said main board acts as a backplane.

2. The method as claimed in claim 1, said method further comprising the step of embedding the BTS control board and the backplane in the main board, and wherein the digital combiner is embedded between the at least one channel card and the at least one IF board of the main board.

3. The method as claimed in claim 1, wherein I/Q data inputted from the forward path are combined to transmit serial data to individual channels of the at least one IF board, and wherein data inputted from the at least one IF board are transmitted via the switching logic in the reverse path.4
